(19) United States
(12) Patent Application Publication
(10) Pub. No.: US 2017/0221348 A1
(43) Pub. Date: Aug. 3, 2017

(54) SYSTEM FOR LOCATING A PORTABLE ELECTRONIC DEVICE AND KEYS

(71) Applicant: Robert House, Bonne Terre, MO (US)

(72) Inventor: Robert House, Bonne Terre, MO (US)

(21) Appl. No.: 15/008,829

(22) Filed: Jan. 28, 2016

(51) Int. Cl. G08B 25/10

(52) U.S. Cl. CPC G08B 25/10

(57) ABSTRACT

A system for locating a portable electronic device comprising: a key ring; a FOB attached to the key ring; a case, where the case holds the portable electronic device; an electronic signal transmitted between the FOB and the case; a software application, where the software application resides on a memory of the portable electronic device; an audible alert emitted from the key FOB; and a button on the FOB, where the button is adapted to initiate an audible alert from the case. The case preferably includes visual alerts such as flashing lights.

### BACKGROUND OF THE INVENTION

Field of Invention

The present invention relates to a system for locating a portable electronic device and a key ring.

Description of Related Art

Portable electronic devices such as cell phones, tablets and smartphones are widely used throughout society. Essentially most individuals own some form of a portable electronic device. Another commonly misplaced items are keys. It is quite common for individuals to spend a lot of time searching for their keys. As a result, many individuals have trouble locating these items that are occasionally misplaced. A substantial amount of time and frustration may be avoided if a system is developed in order to assist users in finding and locating their portable electronic devices.

### SUMMARY OF THE INVENTION

The present invention relates to a system for locating a portable electronic device comprising: a key ring; a FOB attached to the key ring; a case, where the case holds the portable electronic device; an electronic signal transmitted between the FOB and the case; a software application, where the software application resides on a memory of the portable electronic device; an audible alert emitted from the key FOB; and a button on the FOB, where the button is adapted to initiate an audible alert from the case. The case preferably includes visual alerts such as flashing lights.

### BRIEF DESCRIPTION OF DRAWINGS

FIG. 1 depicts a system for locating a portable electronic device in accordance with the present invention.

### DETAILED DESCRIPTION

The present invention relates to a system for locating a portable electronic device. The present system includes a key ring with a FOB attached to the key ring. This FOB works in conjunction with a case that holds a portable electronic device. The portable electronic device may be a smart phone, a tablet or other suitable electronic device. An electronic signal is transmitted between the FOB and the case that is monitored through a software application installed on memory residing on the portable electronic device. The system according to the present invention provides a means to locate both the key ring and the portable electronic device. The software application provided with the present invention enables a user to locate their keys by the emitting an audible sound from the key FOB. Conversely, the key FOB includes a button that triggers the application to transmit a similar sound from speakers of the portable electronic device. Further, the case used in conjunction with the present invention includes lighting, therefore providing a visual alert to assist in locating the portable electronic device. As a result, the system according to the present invention provides a means for locating both keys and a portable electronic device within the system provided through a software application.

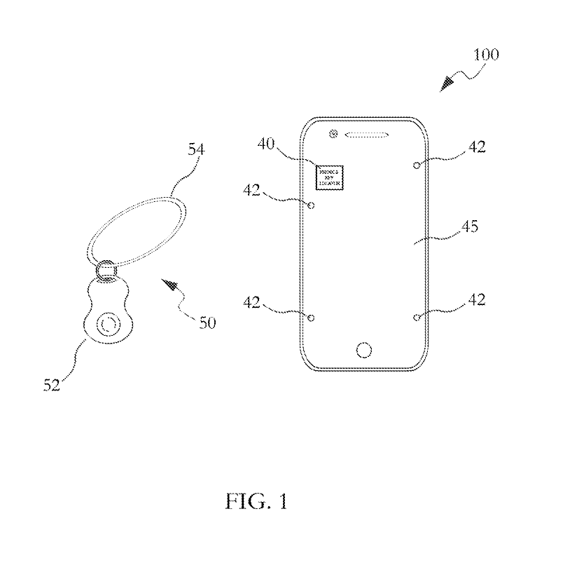

In reference to FIG. 1 a key ring (50) is depicted. Key ring (50) includes FOB (52) and ring (54). The FOB (52) includes a button that activates an audible alert through the electronic device. Conversely the FOB includes an audible alert that is activated through the electronic device (100) shown in FIG. 1. These devices used in conjunction provide a means for locating both the key and the electronic device through the software application (40) installed upon memory within the electronic device (100).

Further the features depicted in FIG. 1 include lighting (42) around the perimeter of the case (100). Further within the case is a portable electronic device (45) with a touch screen that is typically used with most mobile electronic devices available. As a result the system works effectively in both locating a key and a link connected to the electronic device within that case provided with the present invention. The instant invention has been shown and described in what it considers to be the most practical and preferred embodiments. It is recognized, however, that departures may be made there from within the scope of the invention and that obvious modifications will occur to a person skilled in the art.

1. A system for locating a portable electronic device comprising:
a. a key ring;
b. a FOB attached to the key ring;
c. a case, where the case holds the portable electronic device and said case includes visual alerts around the perimeter of the case;
d. an electronic signal transmitted between the FOB and the case;
e. a software application, where the software application resides on a memory of the portable electronic device, wherein the software application is adapted to enable transfer of commands and alerts between the FOB and the case;
f. an audible alert emitted from the key FOB; and
g. a button on the FOB, where the button is adapted to initiate an audible alert and from the case.

2. (canceled)

3. The system for locating a portable electronic device according to claim 1, where the visual alerts includes flashing lights.
